(19) United States
(12) Patent Application Publication
(10) Pub. No.: US 2006/0032140 A1
(43) Pub. Date: Feb. 16, 2006

(54) Sliding window assembly

(75) Inventors: Shigeki Arimoto, Bloomfield, MI (US); Louis William Berklich JR., Lake Orion, MI (US); Beau James Cook JR., Holly, MI (US)

Correspondence Address: WILLIAM M HANLON, JR;YOUNG & BASILE, PC, 3001 WEST BIG BEAVER ROAD, SUITE 624, TROY, MI, 48084-3107, US

(73) Assignee: Hi-Lex Corporation, Troy, MI (US)

(21) Appl. No.: 10/915,242

(22) Filed: Aug. 10, 2004

(51) Int. Cl. E05D 15/10

(52) U.S. Cl. 49/209; 49/413

(57) ABSTRACT

A sliding window assembly for use with a motor vehicle such for example as the rear window of the cab of a pickup type truck. A guide structure mounts a sliding pane for longitudinal sliding movement generally parallel to the plane of the pane between an open position and a closed position, and a lateral thrust mechanism is provided which is operative in response to arrival of the pane in its closed position to thereafter move the pane laterally relative to the plane of the pane into a position wherein the exposed face of the pane is flush with a surrounding vehicle surface such for example as the surface defined by fixed panes in the rear window of a pickup truck. The lateral movement of the pane is accomplished by a guide pin on the glass received in a compound guide slot defined by a fixed guide structure, a slider slidably mounted in a fixed guide structure for movement parallel to the plane of the pane, and a drive mechanism interconnecting the pane and the slider and operative with the pin positioned in a first portion of the compound slot to move the glass along the fixed guide structure in a direction generally parallel to the plane of a pane and operative with the pin positioned in a second angled portion of the compound slot to move the glass pane laterally relative to the plane of the pane.

### BACKGROUND OF THE INVENTION

This invention relates to motor vehicle window assemblies and more particularly to a motor vehicle window assembly including a sliding glass pane moveable between open and closed positions.

There are many motor vehicle applications wherein it is desirable to move a glass pane in a sliding fashion between an open and a closed position. For example, the rear window in a pickup type truck may comprise fixed left and right glass panels and a sliding panel adapted to move between an open position behind one of the fixed glass panels and a closed position in which it is positioned between the fixed panels to seal the window opening.

Many arrangements have been proposed to facilitate the sliding movement of the sliding glass pane between its open and closed positions. However, none of the prior art arrangements have had the ability to move the sliding glass pane in its closed position to a position wherein the face of the sliding glass pane is flush with the face of the fixed glass panes.

### SUMMARY OF THE INVENTION

This invention is directed to an improved sliding window assembly for motor vehicle applications.

More particularly, this invention is directed to the provision of a sliding motor vehicle window assembly wherein the sliding pane in its closed position may assume a position flush with surrounding glass or other vehicular surface.

The sliding window assembly according to the invention comprises a glass pane, a guide structure mounting the pane for longitudinal sliding movement generally parallel to the plane of the pane between an open position and a closed position, and a lateral thrust mechanism operative in response to arrival of the pane at its closed position to thereafter move the pane laterally relative to the plane of the pane. This arrangement allows the glass to be moved longitudinally to its closed position and thereafter moved laterally to a position flush with the fixed adjacent vehicle surface.

According to a further feature of the invention, the guide structure includes a fixed guide structure; a moveable guide structure slidably mounted in the fixed guide structure; at least one guide pin secured to the pane; a compound slot receiving the pin; and a drive mechanism interconnecting the glass pane and the moveable guide structure and operative with the pin positioned in a first portion of the compound slot to move the glass pane along the fixed guide structure in a longitudinal direction generally parallel to the plane of the pane and operative with the pin positioned in a second portion of the compound slot to move the glass pane laterally relative to the plane of the pane. This specific guide structure facilitates the compound movement of the glass pane to its flush position.

According to a further feature of the invention, the first portion of the compound slot comprises an elongated primary portion generally parallel to the plane of the glass pane and the second portion of the compound slot comprises an end portion extending at an angle to the primary portion. This specific slot configuration further facilitates the compound movement of the glass pane.

According to a further feature of the invention, the compound slot has an “L” configuration with the primary portion constituting one leg of the “L” and the end portion constituting another leg of the “L.”

In one embodiment of the invention, the compound slot is defined by a fixed guide structure; the moveable guide structure comprises a slider slidably mounted in the fixed guide structure; a first portion of the pin is received in the compound slot; and a second portion of the pin is received in a slot defined by the slider and angled with respect to the portion of the compound slot.

In further embodiments of the invention, the drive mechanism comprises linkage interconnecting the glass pane and the moveable guide structure. The linkage may comprise a parallel linkage including a pair of parallel links or may comprise a scissors linkage interconnecting the glass pane and the moveable guide structure.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a perspective view of a sliding window assembly according to the invention shown employed to provide a sliding rear window assembly for a pickup truck;

FIG. 2 is an elevational view of the sliding window assembly of FIG. 1;

FIG. 3 is a view showing, in exploded perspective form, component parts of the sliding window assembly of FIGS. 1-2;

FIG. 4 is a further exploded view of component parts of the sliding window assembly;

FIG. 5 is a cross-sectional view taken on line 5-5 of FIG. 4;

FIGS. 6 and 7 are cross-sectional views showing a lateral translatory movement of the sliding window;

FIG. 8 is a fragmentary somewhat schematic plan view further illustrating the lateral, translatory movement of the glass;

FIGS. 9 and 10 are fragmentary perspective and fragmentary plan views of an alternate embodiment of the invention;

FIGS. 11 and 12 are fragmentary perspective and fragmentary plan views of a further alternate embodiment of the invention;

FIG. 13 is a fragmentary perspective view of a yet further alternate embodiment of the invention;

FIGS. 14 and 15 are fragmentary plan views of a yet further embodiment of the invention;

FIGS. 16, 17 and 18 are views of a yet further embodiment of the invention; and

FIGS. 19-22 are views showing the application of the invention to a motor vehicle sunroof

### DETAILED DESCRIPTION OF THE PREFERRED EMBODIMENT

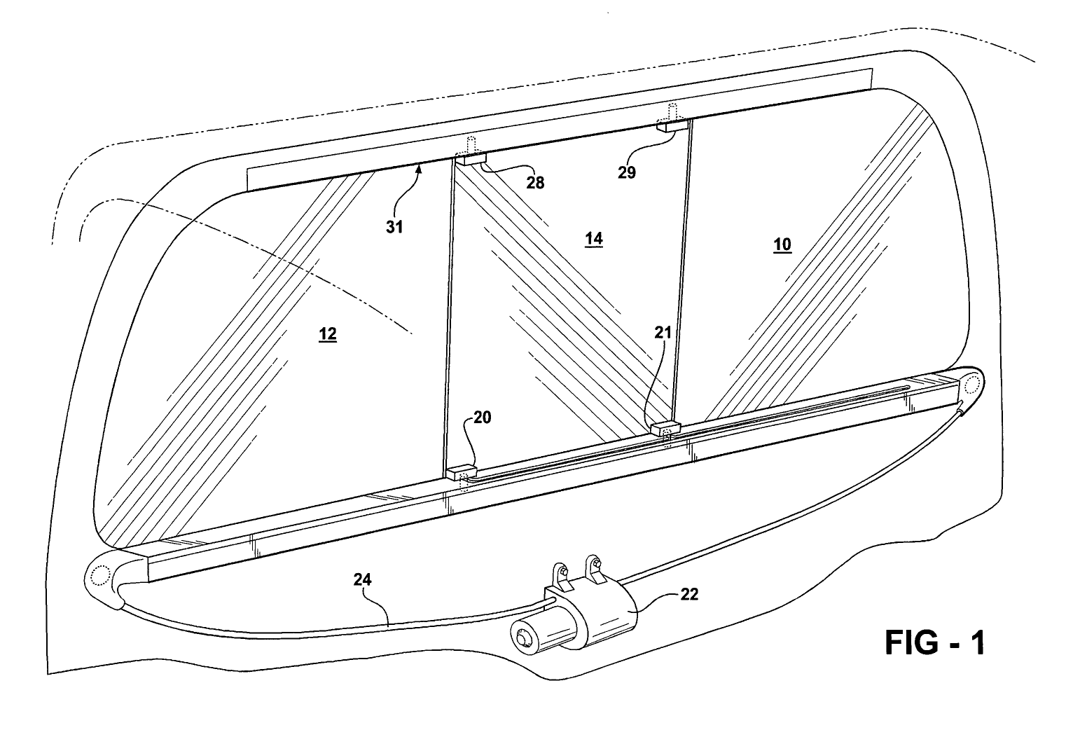

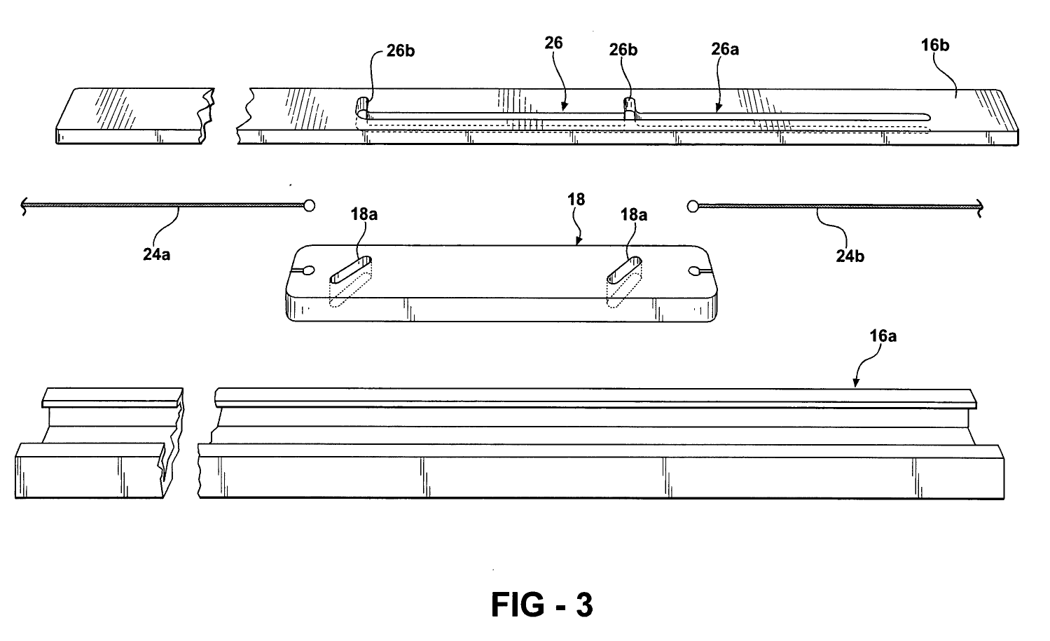

The embodiments of the invention illustrated in FIGS. 1-18 relate to the application of the invention to a sliding window assembly constituting the rear window in the cab of a pickup type motor vehicle.

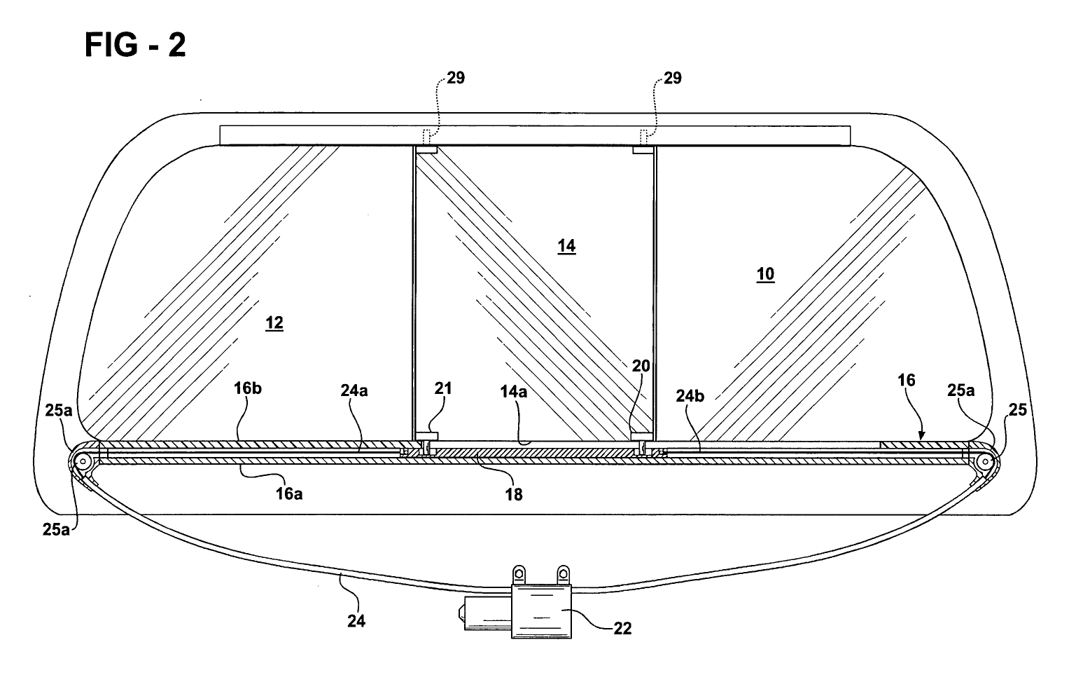

With reference to FIGS. 1-8, the sliding window assembly of the invention is seen embodied as the rear window of the cab of a pickup type motor vehicle with FIGS. 1 and 2 being taken from inside the cab looking rearwardly.

The rear window assembly seen in FIGS. 1 and 2 comprises, broadly considered, a left fixed window pane 10, a right fixed window pane 12, and a moveable or sliding window pane 14 adapted to be moved between the closed position seen in FIGS. 1 and 2, in which it is positioned between fixed panes 10 and 12 to close the rear window assembly, and an open position in which it is positioned behind the fixed pane 10.

The movement of the sliding pane 14 between its open and closed position is accomplished utilizing a mechanism comprising a fixed guide structure in the form of a track 16 positioned within the cab along the lower edge of the glass panes and comprising a lower channel member 16a and an upper slot plate 16b suitably secured to the channel member; a moveable guide structure in the form of a slider 18 positioned slidably in channel member 16a; a pair of pins 20/21 secured at longitudinally spaced locations to a lower edge 14a of the sliding pane 14; and a power mechanism including an electric motor 22 positioned within the cab and driving a cable 24 secured at its opposite ends 24a and 24b to opposite ends of slider 18. Cable ends 24a, 24b are trained around pulleys 25 mounted in pulley housings 25a secured to opposite ends of track 16.

A compound slot 26 is defined by slot plate 16b including a primary slot portion 26a extending gently parallel to the plane of the glass panes and lateral portions 26b extending rearwardly at generally right angles from the primary portion 26a.

A pair of longitudinally spaced, oblique slots 18a are provided in slider 18.

Pins 20/21, slot portions 26b, and slots 18a have identical longitudinal spacing.

In the assembled relation of the parts, pins 20/21 extend downwardly thorough slot 26a for receipt in respective oblique slots 18a.

In operation, and with the sliding pane 14 initially in an open position behind the fixed pane 10, pins 20/21 extend downwardly through the primary portion 26a of slot 26 for receipt in the forward end of respective oblique slots 18a.

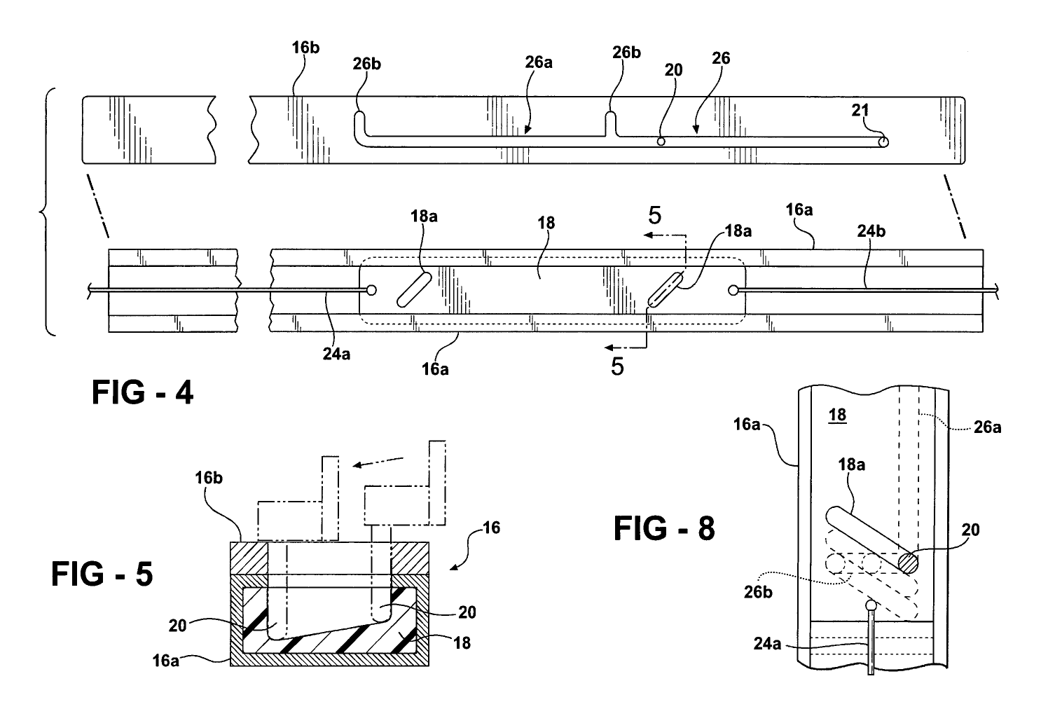

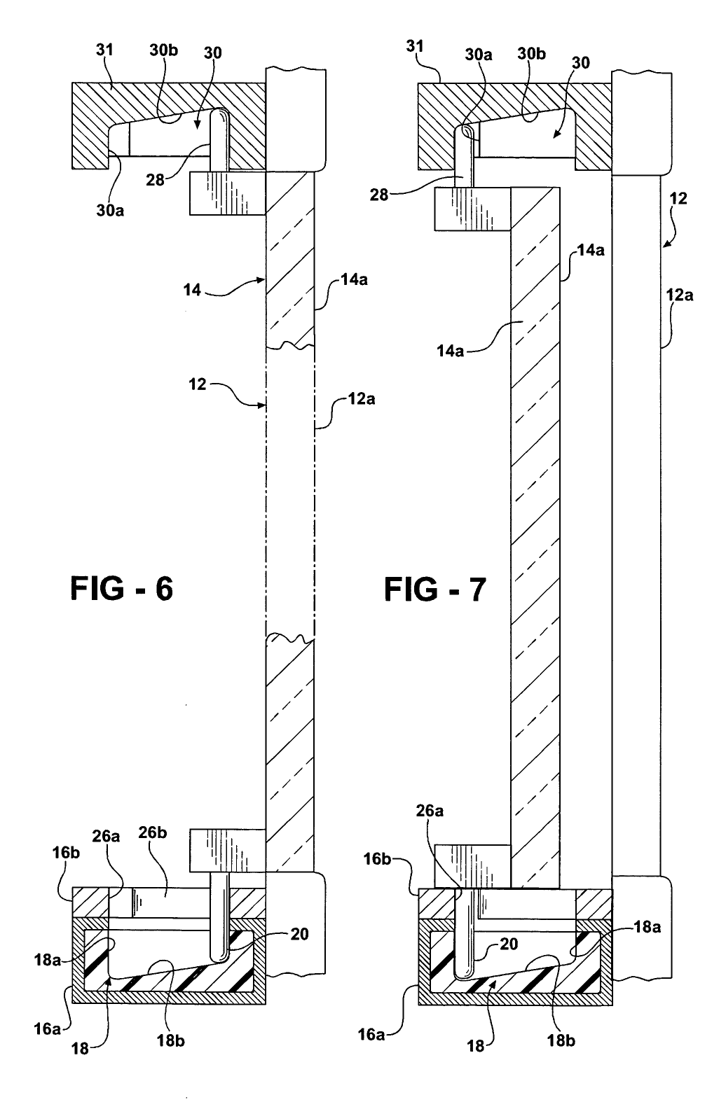

To move the window from the open position to the closed position between the fixed panes 10 and 12, motor 22 is actuated in a sense to drive the cable ends 24a and 24b in a sense to move the slider 18 leftwardly as viewed in FIG. 4. As the slider moves leftwardly, the sliding pane 14 is carried with the slider by virtue of the positioning of the pins 20/21 in the primary slot 26a and in the forward ends of the oblique slots 18a. This leftward longitudinal sliding movement of the slider continues until the leading pin 20 reaches the end 26c of the primary slot 26a at which point the window is positioned generally between the fixed panes 10 and 12. At this point no further longitudinal sliding movement of the window is possible by virtue of the dead ending of the pin 20 in the end 26c of the slot 26. A limited amount of further leftward longitudinal sliding movement of the slider continues with the effect of camming the pins 20/21 rearwardly into the secondary slot portions 26b by virtue of the oblique configuration of the slots 18a relative to the slots 26b. As the pins 20/21 move rearwardly in slot portions 26b the pane 14 is moved laterally and rearwardly into a position between fixed panes 12 and 10 and specifically into a position, seen in FIG. 6, in which the outer or rearward surface 14a of the pane is flush with the outer or rearward surfaces 10a/12a of the fixed panes 10 and 12.

Preferably, the sliding glass assembly further includes upper pins 28 and 29 carried on an upper edge of the sliding pane and guiding in a compound slot 30 in an upper fixed guide 31. Slot 30 has longitudinal and lateral portions 30a, 30b corresponding in configuration to the slot portions 26a, 26b of the slot 26 in slot plate 16.

Further, preferably, sliding pane 14 is moved upwardly slightly as it is moved laterally rearwardly and this upward movement is accomplished by providing an angled bottom 18b to the slots 18a in slider 18 and providing a complementary upwardly angled “bottom” to the slots 30b in the upper guide structure 31. The upward movement of the glass as it moves rearwardly has been found to provide a more positive sealing action of the glass as it moves into its closed position and also deters breaking into the vehicle through the rear window of the cab since any attempted unauthorized inward or forward movement of the pane 14 is resisted by the wedging interference fit between the upper pins 28/29 and the angled surfaces 30b.

Movement of the sliding pane back to its open position is of course accomplished by reversal of the motor 22 with a reversed movement of the cable ends 24a, 24b with the initial movement of the slider to the right as viewed in FIG. 4 having the effect of camming the pins 20/21 forwardly out of the secondary slots 26b and into the primary slot 26a whereafter further sliding movement of the slider 18 to the right moves the pane 14 back to its open position behind the fixed pane 10.

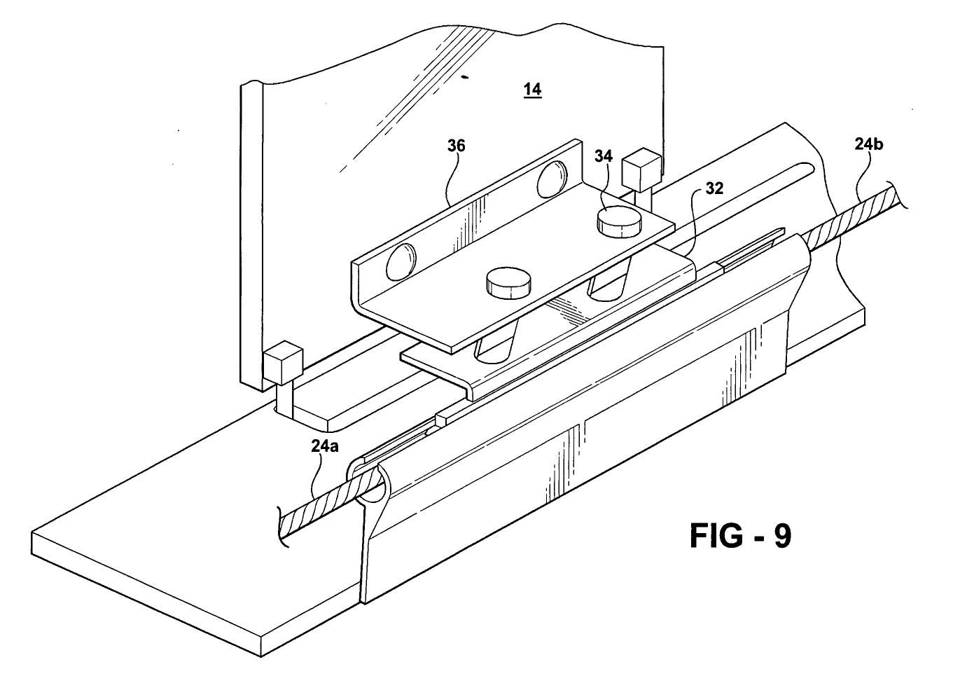

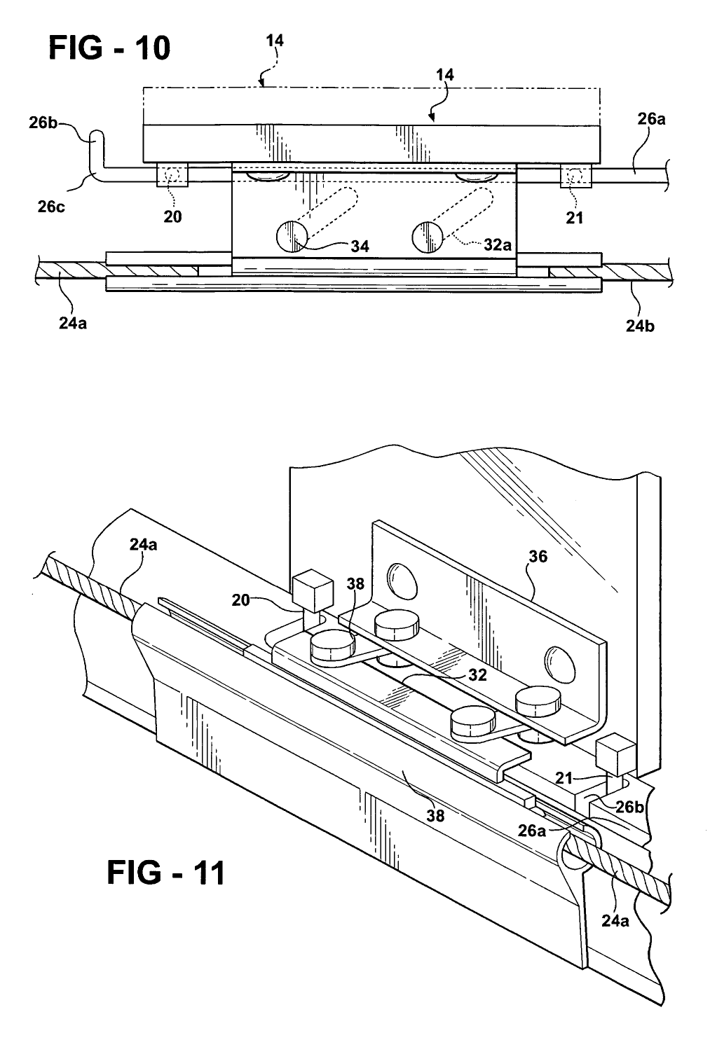

In the modified form of the invention seen in FIGS. 9 and 10, pins 20, 21 continue to glide in a compound slot 26a/26b, (in this case defined by a fixed guide member 33) but the moveable guide member now takes the form of an angled slider plate 32 slidably mounted in a tubular guide 34 and connected to cable ends 24a, 24b. Slider plate 32 defines oblique slots 32a corresponding to slots 18a in the FIGS. 1-8 embodiment and the slots respectively receive pins 34 carried by an angle bracket 36 secured to the lower edge of the sliding glass pane 14. In the operation of this embodiment of the invention, as the window moves from its open to its closed position, pins 20/21 track in slot 26a and pins 34 are received in the forward ends of slots 32a until the pane arrives at a position generally between the fixed glass panes whereupon the pin 20 bottoms in the end 26c of slot 26a and the oblique slots 32a thereafter coact with the pins 34 to slide the glass rearwardly and laterally into a flush position relative to the fixed panes with the pins 20/21 moving into the secondary slot portions 26b to accommodate this rearward lateral movement.

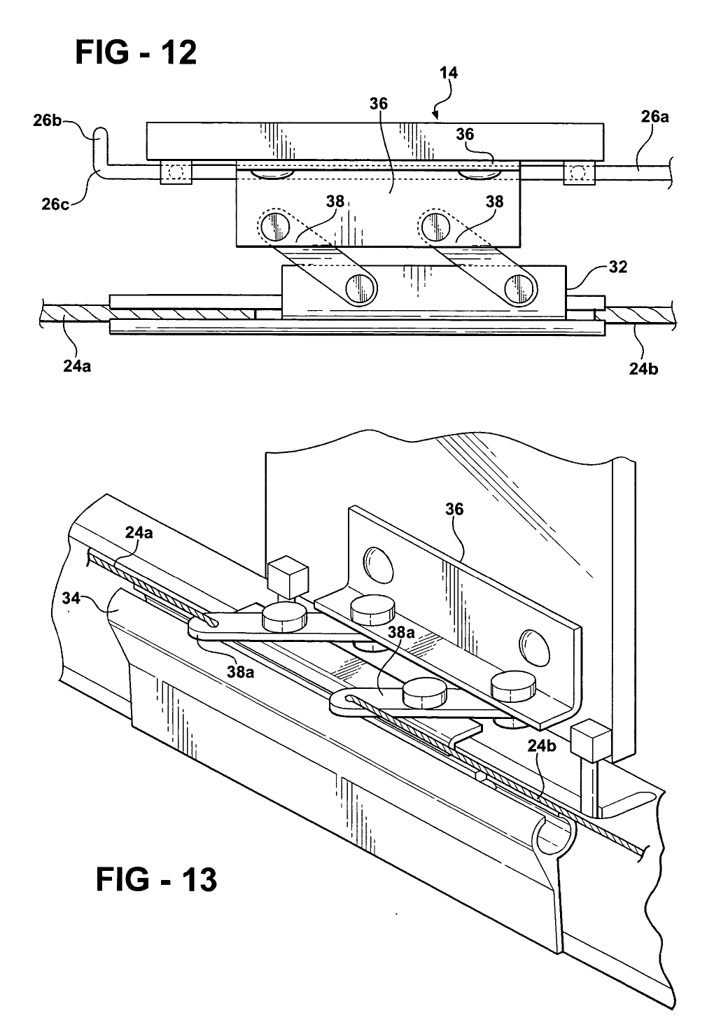

The embodiment seen in FIGS. 11 and 12 is generally similar to the embodiment of FIGS. 9-10 with the exception that the pin and slot connection 32a/34 of the FIG. 9/10 embodiment is replaced by a parallel linkage consisting of links 38 pivotally interconnecting the slider 32 and the glass bracket 36 so that as the pin 20 reaches the end 26c of the primary slot portion 26a, continued longitudinal sliding movement of the slider has the effect of straightening out the links 38 and moving the glass pane rearwardly and laterally into a flush position with respect to the fixed panes with, again, the rearward lateral movement being accompanied by and accommodated by movement of the pins 20, 21 into the secondary, rearwardly extending slot portions 26b.

The embodiment seen in FIG. 13 is generally similar to the FIGS. 11/12 embodiment with the exception that the cable ends 24a/24b, rather than being secured to opposite ends of the slider plate 32, are secured to forward extensions 38a of the parallel links 38 with the structure of the assembly otherwise corresponding to the FIGS. 11/12 embodiment and the operation otherwise corresponding to the FIGS. 11/12 embodiment.

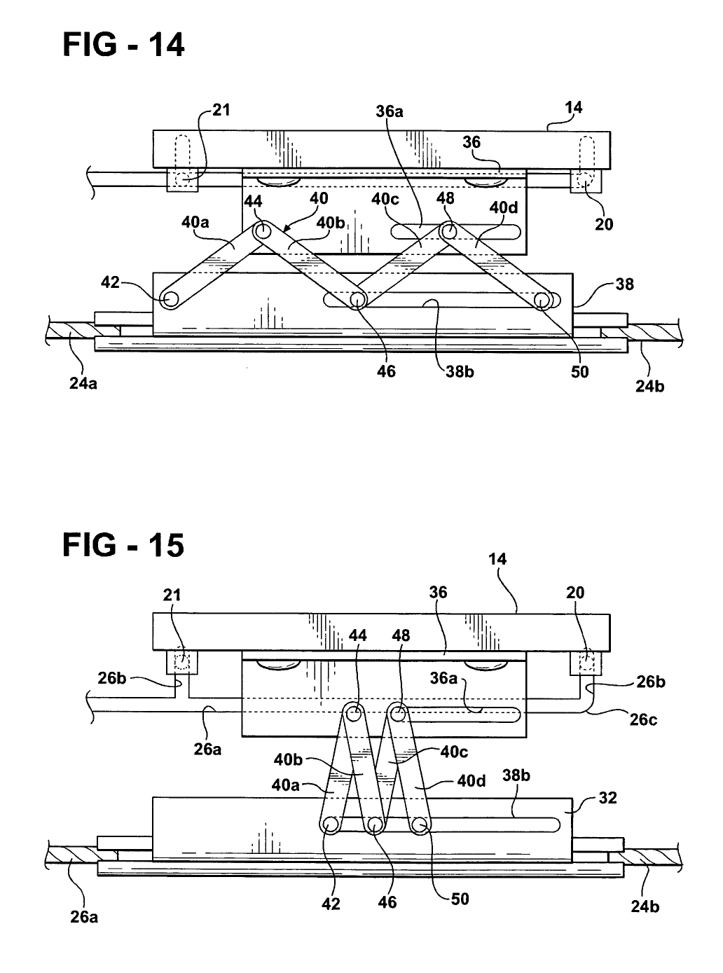

In the embodiment of FIGS. 14 and 15, the parallel links 38 interconnecting the slider plate 38 and the glass bracket 36 are replaced with a scissors linkage 40 comprising links 40a, 40b, 40c and 40d. Link 40a is pivoted to slide plate 38 by a pin 42; links 40a and 40b are pivotally interconnected by a pin 44; links 40b and 40c are pivotally interconnected by a pin 46; links 40c and 40d are pivotally interconnected by a pin 48; and the free end of link 40d carries a pin 50. Pin 44 is pivotally mounted on glass bracket 36, pins 46 and 50 are slidably mounted in a slot 38b in slider plate 38, and pin 48 is slidably mounted in a slot 36a in bracket 36. As will be seen from a comparison of FIGS. 14 and 15, as the pin 20 reaches the end of primary slot portion 26a, continued forward movement of the slider plate 38 (in this case to the right as viewed in FIG. 15) has the effects of collapsing the scissors linkage and moving the bracket 36 and pane 14 outwardly into a flush position relative to the fixed panels with, again, this rearward lateral movement being accompanied by and accommodated by movement of the pins 20 and 21 into the rearwardly extending secondary slot portions 26b.

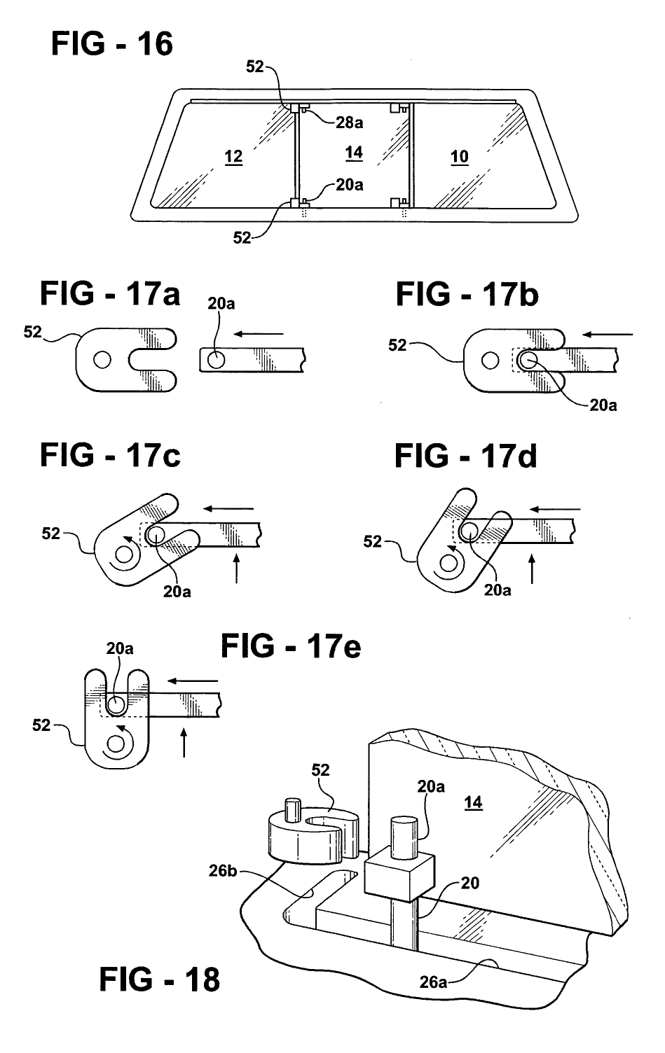

In the embodiment of the invention seen in FIGS. 16, 17 and 18, the lateral rearward movement of the moveable glass pane 14 into a position flush with the fixed panes is accomplished by cams 52 pivotally mounted to spaced locations on the fixed pane 12 and coacting with upward and downward extensions 20a, 28a, respectively, of the leading pins 20, 28. Specifically, and as best seen in FIGS. 17a though 17e, the cams 52 receive the upward extension 20a of the leading pin 20 and the downward extension 28a of the leading pin 28 and then gradually pivot about their pivot axes 52a to move the glass rearwardly and laterally into its flush position relative to the fixed panes with the lower pins 20/21 and the upper pins 28/29 again moving rearwardly and laterally in lateral slot portions to accompany and accommodate the rearward lateral movement of the pane 14. The lateral slot portions in this case would be somewhat oblique with respect to the primary longitudinal slot portion to accommodate the path of rearward movement of the pins as defined by the pivotal movement of the cam members.

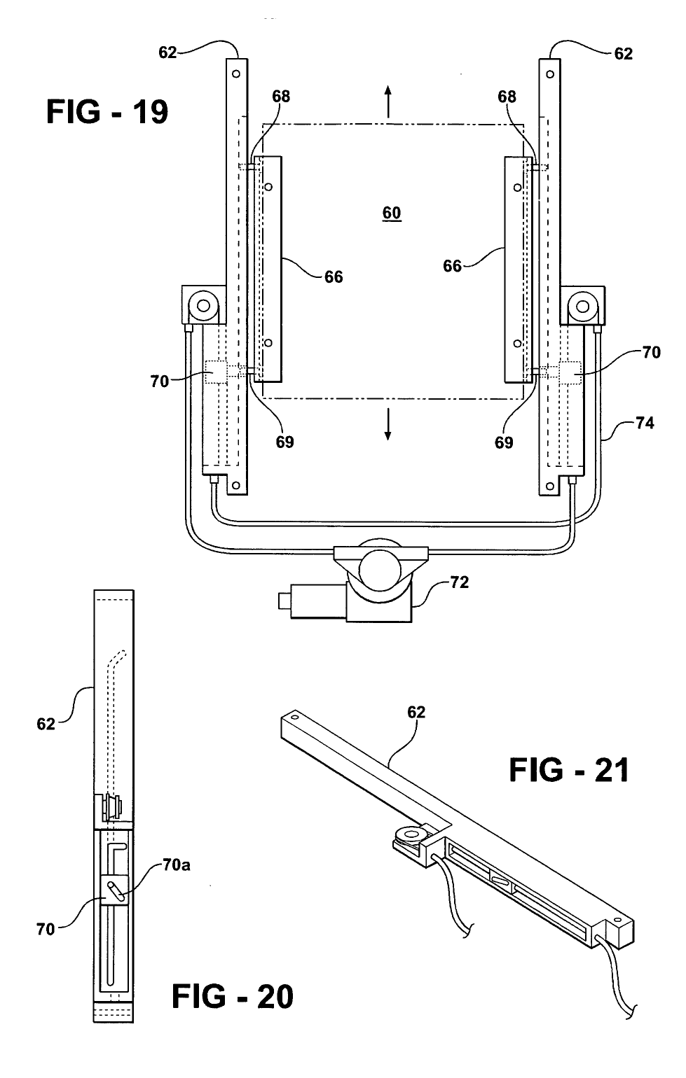

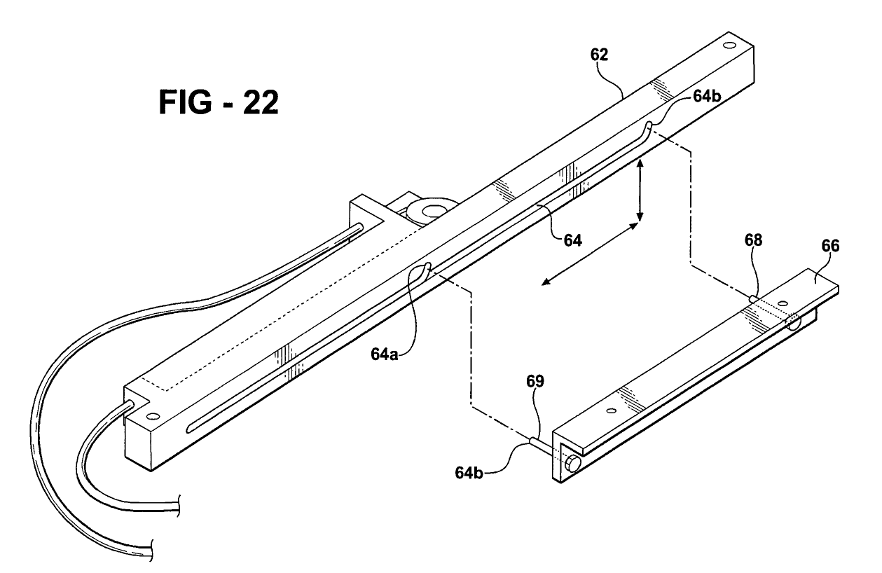

All of the embodiments heretofore described are contemplated for use with the rear window of the cab of a pickup type motor vehicle. The embodiment seen in FIGS. 19-22 is intended for use with a mechanism of the “sunroof” type wherein a glass pane 60 is moved into and out of a position within an opening in the roof of a motor vehicle with the glass, as in the previous embodiment, undergoing initially a sliding movement into a position proximate the opening and thereafter undergoing a lateral movement into a position flush with a surrounding surface of the motor vehicle. The sliding window mechanism of the FIGS. 18-22 embodiment includes a pair of tracks 62 each defining a compound slot 64; a pair of brackets 66 secured to opposite edges of the pane 60 and carrying pins 68/69 for sliding receipt in slots 64; a slider 70 slidably mounted in each track 62; and a power mechanism including an electric motor 72 driving a cable system 74. The rear pin 69 of each window bracket 66 passes through the respective slots 64 for engagement with an oblique slot 70a in a respective slider 70 so that, as the window arrives at its closed position relative to the opening in the motor vehicle roof, the sliders 70 continue to move forwardly with the oblique cam slot 70a coacting with the pins 69 to move the glass pane laterally upwardly relative to the plane of the glass with the movement being accompanied and accommodated by movement of the pins 69 into the secondary slot portions 64a. Note that, in this case, the forward pins 68 are not received in sliders 70 but rather move into oblique portions 64b of compound slots 64 to move the forward end of the glass laterally upwardly as the rearward end is moved laterally upwardly by the movement of the pins 69 into the slot portion 64a.

The invention will be seen to provide a sliding glass assembly for a motor vehicle which is simple and efficient in operation and which facilitates the movement of the sliding pane to a position flush with an adjacent surface of the motor vehicle such, for example, as an adjacent surface defined by fixed panes in the rear window of the cab of the pickup type motor vehicle or an adjacent roof surface in the case of a sunroof.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A sliding window assembly comprising:
a sliding pane assembly including a glass pane;
a guide structure mounting the glass pane for longitudinal sliding movement generally parallel to the plane of the pane between an open position and a closed position; and
a lateral thrust mechanism operative in response to arrival of the pane at its closed position to thereafter move the pane laterally relative to the plane of the pane.

2. A sliding window assembly according to claim 1 wherein;
the sliding pane assembly further includes a guide pin secured to the glass pane;
the guide structure includes a track and a slider slidably mounted in the track; and
the lateral thrust mechanism includes a compound slot receiving the pin and a slot in the slider angled with respect to one portion of the compound slot in the track.

3. A sliding window assembly according to claim 2 wherein the compound slot has an “L” configuration with the primary portion constituting one leg of the “L” and the end portion constituting another leg of the “L.”

4. A sliding window assembly according to claim 3 wherein the other leg of the “L” is generally perpendicular to the one leg and the slider slot is oblique with respect to the plane of the glass pane.

5. A sliding window assembly according to claim 2 wherein the pin is also received in the slider slot.

6. A sliding window assembly comprising:
a glass pane;
at least one guide pin secured to the pane;
a fixed guide structure;
a moveable guide structure slidably mounted in the fixed guide structure;
a compound slot receiving the pin; and
a drive mechanism interconnecting the glass pane and the moveable guide structure and operative with the pin positioned in a first portion of the compound slot to move the glass along the fixed guide structure in a direction generally parallel to the plane of the pane and operative with the pin positioned in a second portion of the compound slot to move the glass pane laterally relative to the plane of the pane.

7. A sliding window assembly according to claim 6 wherein the first portion of the compound slot comprises an elongated primary portion generally parallel to the plane of the glass pane and the second portion of the compound slot comprises an end portion extending at an angle to the primary portion.

8. A sliding window assembly according to claim 7 wherein the compound slot has an “L” configuration with the primary portion constituting one leg of the “L” and the end portion constituting another leg of the “L.”

9. A sliding window assembly according to claim 8 wherein the other leg of the “L” is generally perpendicular to the one leg and the moveable guide structure includes a slot obliquely disposed with respect to the plane of the glass pane.

10. A sliding window assembly according to claim 9 wherein the pin is also positioned in the slider slot.

11. A sliding window assembly comprising:
a glass pane;
at least one guide pin secured to the pane;
a fixed guide structure defining a compound slot receiving a first portion of the pin; and
a moveable guide structure slidably mounted in the fixed guide structure and defining a slot receiving a second portion of the pin and angled with respect to a portion of the compound slot.

12. A sliding window assembly according to claim 6 wherein the drive mechanism comprises a parallel linkage interconnecting the glass pane and the moveable guide structure.

13. A sliding window assembly according to claim 12 wherein:
the parallel linkage comprises a pair of parallel links each pivotally connected at one end to the glass pane and at an intermediate point to the moveable guide structure; and
the drive mechanism further includes cable means connected to the other end of both links.

14. A sliding window assembly according to claim 6 wherein the drive means comprises a scissors linkage interconnecting the glass pane and the moveable guide structure and moveable from an expanded configuration to a contracted configuration in response to movement of the pin from the first portion of the compound slot to the second portion of the compound slot.

15. A sliding window assembly according to claim 1 wherein:
the assembly further includes a drive member slidably mounted in the guide structure; and
the lateral thrust mechanism comprises linkage interconnecting the glass pane and the drive member.

16. A sliding window assembly according to claim 15 wherein the linkage comprises a parallel linkage interconnecting the drive member and the glass pane.

17. A sliding window assembly according to claim 15 wherein the linkage comprises a scissors linkage interconnecting the drive member and the glass pane.

18. A sliding window assembly according to claim 15 wherein:
the sliding window further includes at least one guide pin secured to the glass pane and a compound slot receiving the pin; and
the linkage operates to move the glass pane laterally in response to movement of the pin from a first portion of the compound slot to a second portion of the compound slot angled with respect to the first portion.
